(19) United States
(12) Patent Application Publication
(10) Pub. No.: US 2006/0250347 A1
(43) Pub. Date: Nov. 9, 2006

(54) Flat panel display mounting system

(75) Inventor: Luciano Bertoncini, Treviso (IT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Bell'O International, L.L.C., Morganville, NJ (US)

(21) Appl. No.: 11/031,163

(22) Filed: Jan. 7, 2005

Related U.S. Application Data
(60) Provisional application No. 60/535,090, filed on Jan. 8, 2004.

(51) Int. Cl. G09G 3/36

(52) U.S. Cl. 345/103

(57) ABSTRACT

A mounting system for a unit including a flat panel display unit such as a plasma or LCD television is disclosed. The mounting system includes at least one cable in cooperation with a bracket configured to support a lower portion of flat panel display unit.

### CROSS REFERENCE TO RELATED APPLICATION

This application claims the benefit of the filing date of U.S. Provisional Patent Application No. 60/535,090 filed Jan. 8, 2004, the disclosure of which is hereby incorporated herein by reference.

### FIELD OF THE INVENTION

This invention relates to a flat panel display mounting system and a method of mounting a flat panel display.

### BACKGROUND OF THE INVENTION

The last several years have been marked by tremendous growth in the popularity of flat panel displays, and in particular, flat panel televisions. Flat panel televisions presently use one of two technologies, either liquid crystal display or plasma display, to provide a display screen that is much thinner and lighter than traditional cathode ray televisions or projection televisions. Flat panels televisions are also versatile in that they can be placed on a stand or mounted on numerous surfaces.

The variety of flat panel televisions available flat panel televisions available is increasing as more manufacturers enter the market and larger flat panel televisions are produced. Presently, each manufacturer of flat panel television offers mounting brackets, stands or other hardware uniquely designed to mount their flat panel television on a wall or television stand. There are also mounting systems available that can be used interchangeably with different flat panel televisions, however, these mounting systems typically require a mounting plate that is specific to each specific flat panel television product.

It would be advantageous to provide a flat panel display mounting system that could be universally used to mount a wide variety of flat panel displays.

### SUMMARY OF THE INVENTION

According to one or more embodiments of the invention, a flat panel display mounting system is provided.

The flat panel display mounting system comprises a bracket to support a lower portion of the flat panel display and at least one cable that is mountable to the flat panel display and the bracket. In preferred embodiments, a tension adjustment mechanism is provided to adjust the tension of the cables.

One or more embodiments of the present invention are directed to a universal mounting system for flat panel displays. As used herein, the term “flat panel display” is intended to cover televisions, computer monitors and any other relatively flat display device for displaying images regardless of the underlying technology utilized to create the images (e.g., plasma, LCD, LED, etc.).

### BRIEF DESCRIPTION OF THE DRAWINGS

A more complete appreciation of the subject matter of the present invention and the various advantages thereof can be realized by reference to the following detailed description in which reference is made to the accompanying drawings.

FIG. 1 is a perspective rear view of a mounting system supporting a flat panel display screen according to one embodiment of the present invention;

FIG. 2 a perspective rear side view of the mounting system shown in FIG. 1 supporting a flat panel display screen;

FIG. 3 is a partial rear perspective view of the mounting system shown in FIG. 1 supporting a flat panel display screen;

FIG. 4 is an enlarged perspective view showing one of the ratchets used in the mounting system of FIG. 1;

FIG. 5 is a partial rear perspective view showing a portion of cables of the mounting system of FIG. 1;

FIG. 6 is another partial rear perspective view showing attachment of cables to the flat panel display;

FIG. 7 is a rear view showing a portion of a the support bracket used in the mounting system shown in FIG. 1;

FIG. 8 is a front perspective view of a television stand using the mounting system shown in FIG. 1 and having a flat panel television mounted thereto according to one embodiment of the invention;

FIG. 9 is an exploded perspective view some components of the mounting system shown in FIG. 1;

FIG. 10 is a an exploded front perspective view of another embodiment of a mounting system designed to be mounted on a wall or other support panel;

FIG. 11 is an assembled front perspective view of the mounting system of FIG. 10;

FIG. 12 is a side view of the mounting system shown in FIG. 11;

FIG. 13 is a rear perspective front view of the mounting system shown in FIG. 11 excluding the cables;

FIG. 14 is a perspective front view of the bracket from the mounting system of FIGS. 10-13;

FIG. 15 is a perspective rear view of the wall mount bracket shown in FIG. 14;

FIG. 16 is a perspective view of a panel mounting system according to another embodiment of the present invention; and

FIG. 17 is a perspective view of a flat panel television mounted by the panel mounting system of FIG. 16.

### DETAILED DESCRIPTION OF THE PREFERRED EMBODIMENTS

One or more embodiments of the present invention provide a mounting system including a bracket that supports a flat panel display and at least one cable. In preferred embodiments, a pair of cables is attached to a portion of a flat panel display unit, and the cables are also attached to the bracket. A tension adjustment mechanism is used to increase or decrease the tension on the cables to aid in securing the flat panel display unit.

Advantageously, the mounting system according to one or more embodiments of the present invention can be used with any flat panel display unit. Such display units are often used in the production of televisions and computer monitors. The embodiments of the present invention provide a simple and convenient system and method for mounting and displaying flat panel display units.

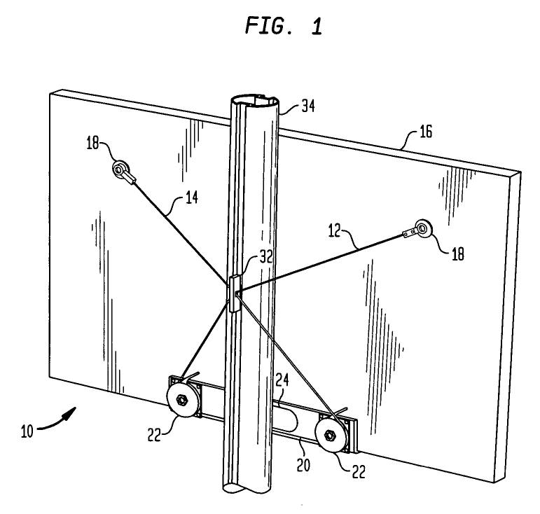

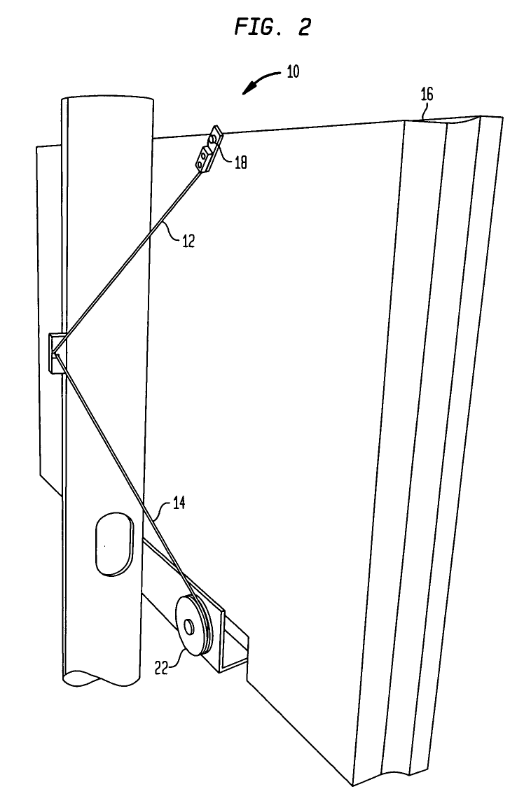

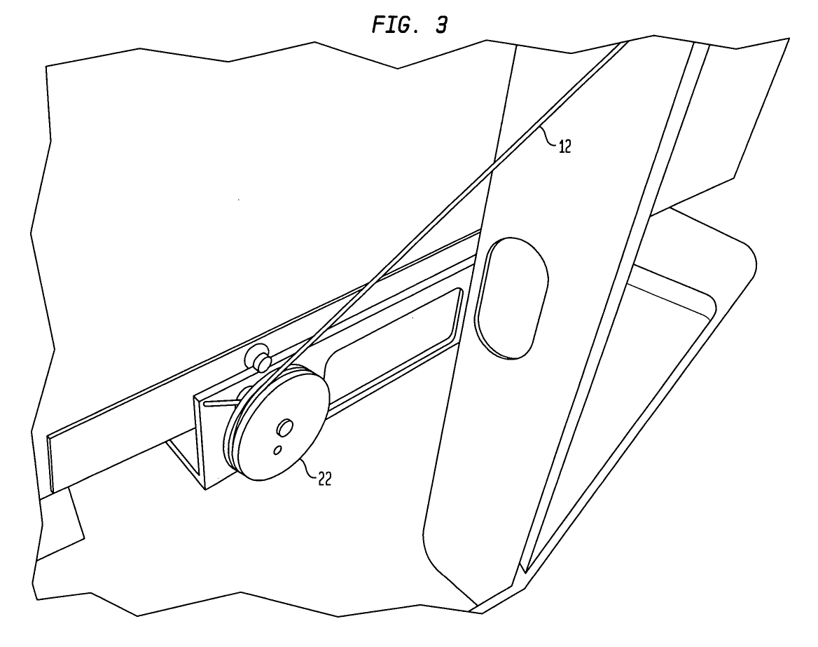

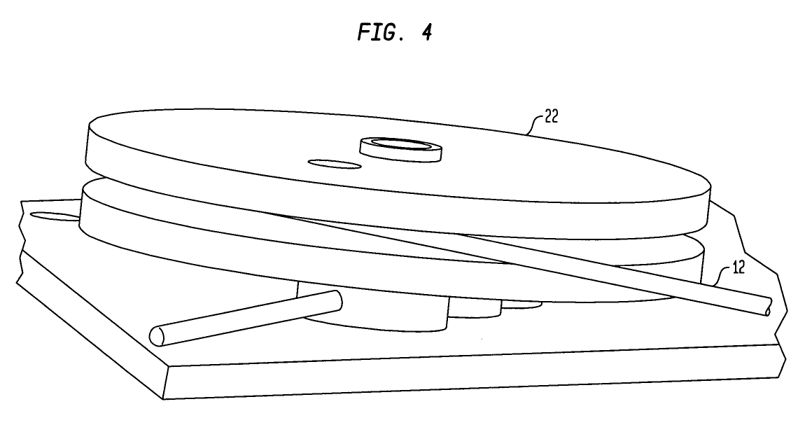

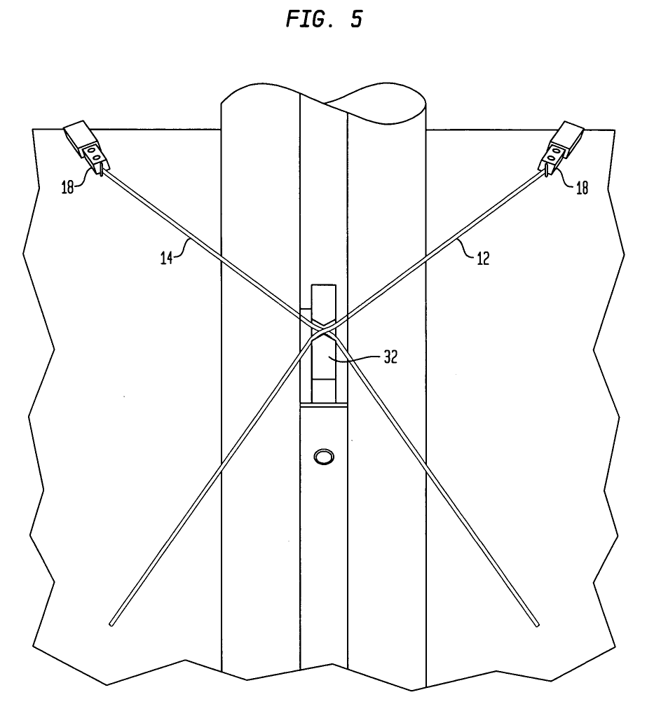

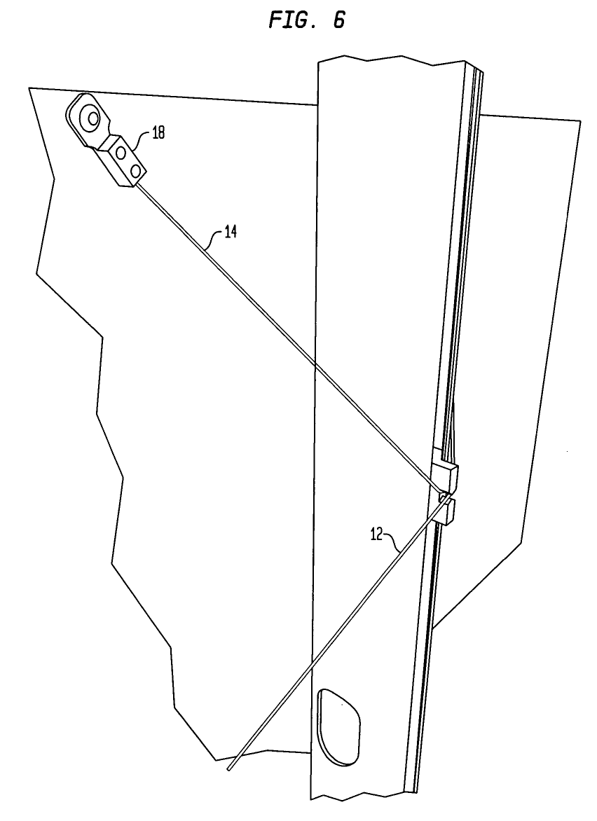

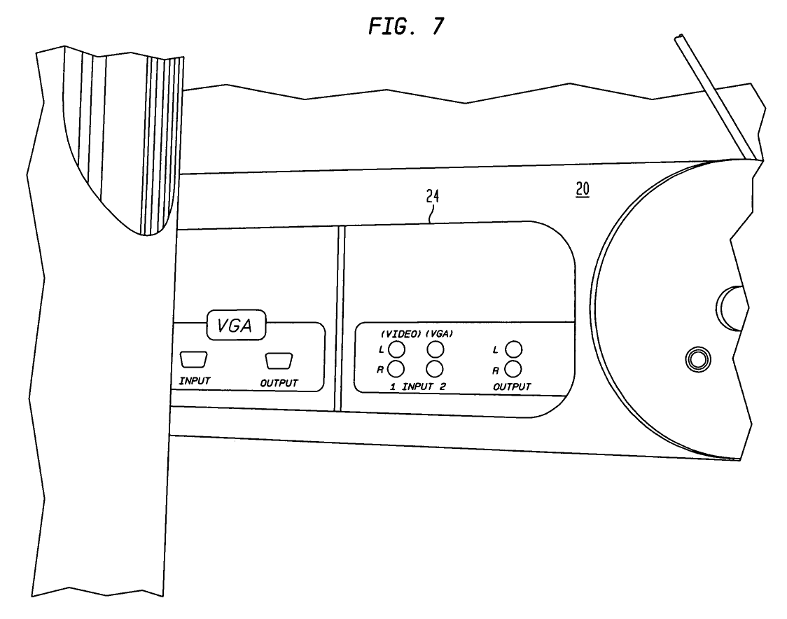

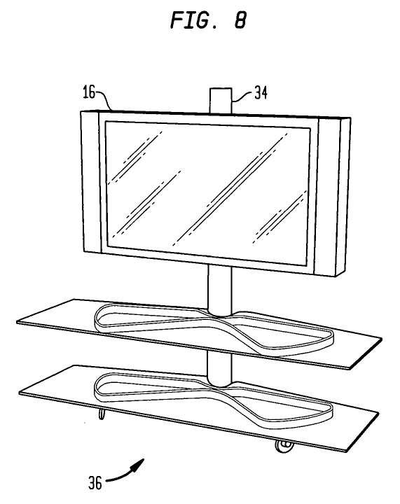

Turning now to the drawings and particularly to FIGS. 1-8, a mounting system according to one or more embodiments of the present invention is shown generally by reference numeral 10. The mounting system 10 shown in FIGS. 1-8 includes a first cable 12 and a second cable 14. A first portion of each cable 12, 14 is configured to be attached to a flat panel display unit 16. All commercially available flat panel display units are provided with threaded holes on the rear portion thereof to facilitate suspension and mounting of the flat panel display. However, the spacing of these holes varies for different manufacturers and models. According to one or more embodiments, an end portion of each cable 12, 14 may include a connector 18, having an opening for receiving a fastener such as a screw or bolt or the like. The connector 18 could also be a separate component that is fastened to an end portion of each cable 12, 14. Still further, the connector could be a loop or other structure on the end of the cable that can accept a fastener such as a screw or bolt or the like.

The other end of each cable 12, 14 is attached to a bracket 20 that is configured to support a flat panel display. As shown in the drawings, the bracket 20 is shown as being L-shaped, but the bracket could also be any convenient shape to support a lower portion of a flat panel display. For example, the bracket could be U-shaped, J-shaped, V-shaped, etc. to provide a surface that supports a lower portion of a flat panel display 16 that is either flat on the bottom edge or is not flat on the bottom edge. Alternatively, multiple support brackets can be used for a single flat panel display.

The ends of the cables 12, 14 are preferably attached to the bracket by a cable adjustment device. As shown in the Figures, the cable adjustment device can be in the form of ratchet devices 22, which includes a pulley system. In preferred embodiments, the ratchet devices 22 are mounted on opposing sides of the bracket 20, and in a manner so that each of the cables 12, 14 extend diagonally across a rear portion of the flat panel display 16. The bracket 20 preferably includes at least one opening 24, which provides access to the rear of the display unit so that communication cables can be connected to the rear of the unit. Although a pair of openings 24 is shown in the Figures, a single opening could be provided. In addition, the size of the opening could be adjustable by using a bracket comprised of two separate pieces that can be slidably adjusted with respect to each other. Such an opening may be adjustable to accommodate a flat panel display 16 that is not flat on its bottom edge.

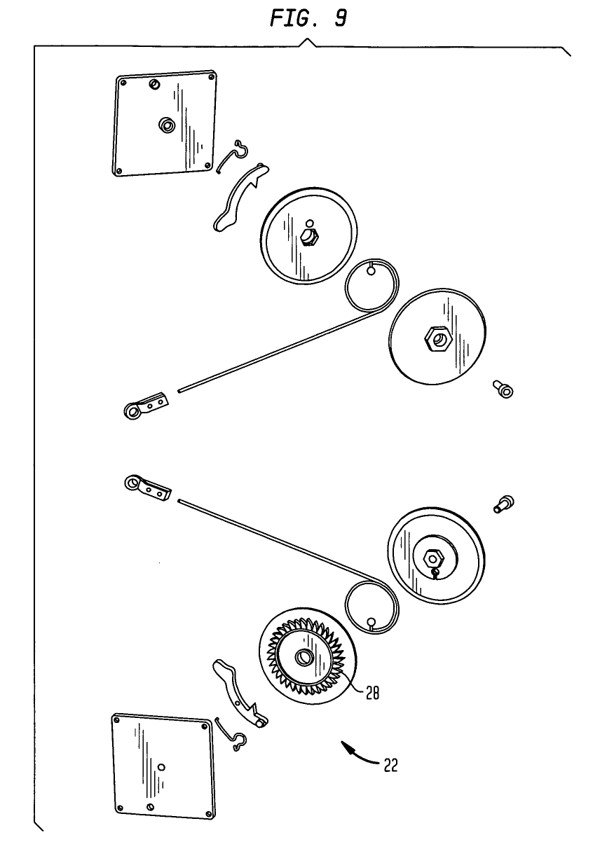

In a preferred embodiment, the mounting system 10 includes a cable tension adjustment mechanism. In the embodiment shown in FIGS. 1-8, the tension adjustment mechanism includes a ratchet device. Ratchet devices are known in the art, and an exemplary ratchet device 22 is shown in FIG. 9 as including a toothed wheel 28 and a pawl 30 that engages the toothed wheel 28 to prevent inadvertent rotation of the pulley in one direction. The tension on the cables 12, 14 could be adjusted by other means as well. For example, the connector 18 could include a mechanism that allows the tension on the cables 12, 14 to be slidably adjusted. For example, detents or other structures could be provided to allow the tension on the cables to be adjusted by sliding the cables with respect to the detents.

In use, the mounting system 10 can be used to mount a flat panel display to a conventional television stand, a wall or a panel that can be incorporated with a television stand. In the embodiment shown in FIGS. 1-8, a first end of each cable 12, 14 is secured to a rear portion of a display unit 16 by placing a screw or a bolt through an opening associated with the connector 18 at the end of each cable 12, 14, and tightening the screw or bolt to the rear portion of the display unit 16 to rigidly secure the cable ends to the display unit. The cables 12, 14 are arranged so that they form an “X” and cross each other. A notched member 32 holds the cables 12, 14 at their point of crossing. Instead of a notched member 32, another structure could be provided such as a hole or opening through which the cables can be inserted. The other ends of each cable 12, 14 are secured to ratchet devices 22 that are attached to opposite ends of bracket 20. After a lower portion of the display has been situated on the bracket 20 and the connectors 18 have been attached to the flat panel display 16, the tension of the cables 12, 14 can be adjusted to secure the position and angle of the screen.

In the embodiment shown in FIGS. 1-8, the notched member 32 is secured to a mounting post 34 that can be associated with a furniture stand 36 that may include shelves or other components for holding auxiliary components that may be used with a flat panel display. For example, the shelves may be used to hold a VCR, DVD player, home theater system, or media that may be played in these devices.

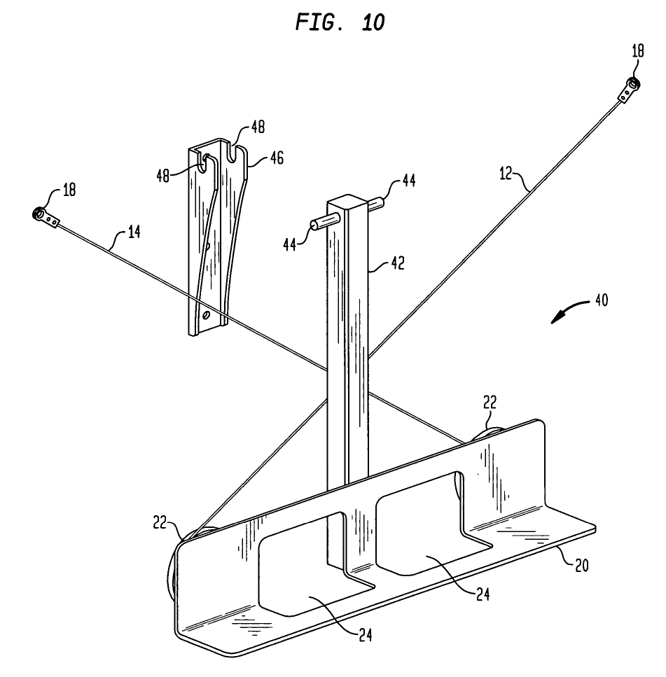

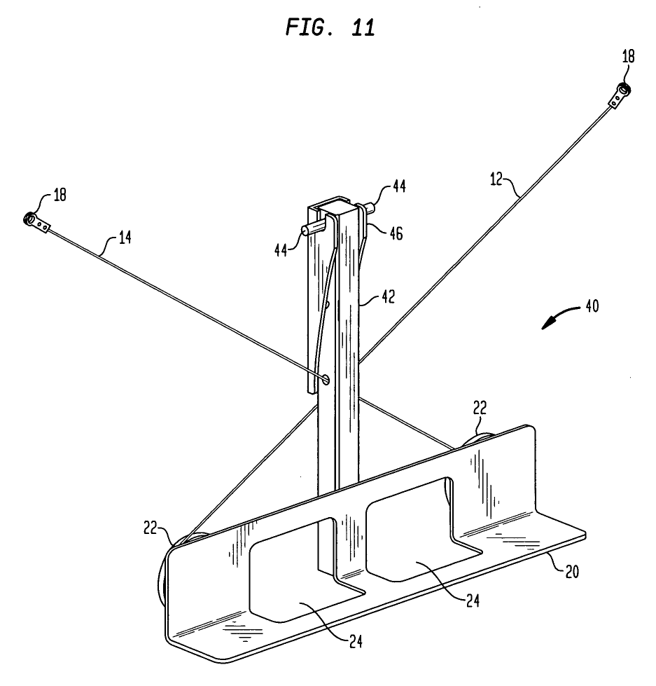

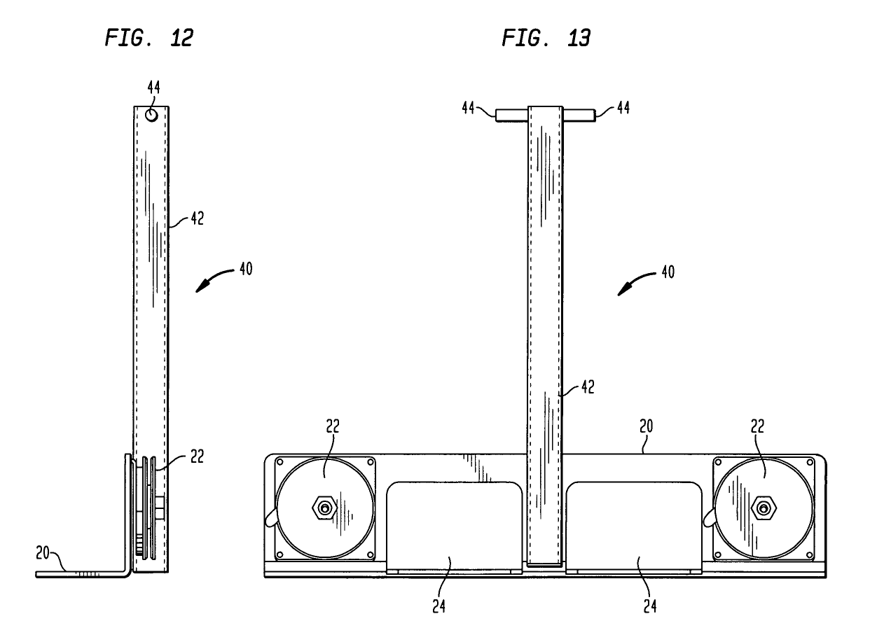

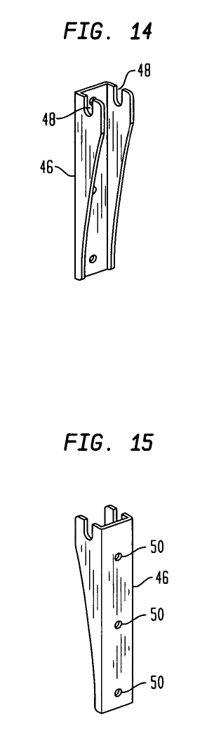

In another embodiment of the invention, in which like reference numerals denote similar components, the mounting system 40 can be used to secure a flat panel display unit to a surface such as a flat panel or a wall. Thus, according to an embodiment shown in FIGS. 10-15, a mounting system 10 for mounting a flat panel display such as a plasma television to a wall includes at least one cable, and preferably a pair of cables 12, 14 that can be mounted to a rear portion of a flat panel display. A first end of each cable 12, 14 includes a connector for connecting the cables to a flat panel display using fasteners such as screws or bolts. The cables preferably cross each other to form an “X” pattern, and the other end of each cable 12, 14 is associated with a bracket 20. Preferably, the cables are fastened to ratchet devices 22 mounted on opposite sides of the bracket 20. As in the previously described embodiment, the bracket can be L-shaped, but it could also be formed in other shapes convenient for supporting a flat panel display.

Openings 24 facilitate access to the rear of the flat panel display. In the embodiment shown in FIGS. 10-15, the bracket 20 is connected to or integral with a hanger member 42 that includes projections 44 that is configured to cooperate with a wall bracket 46. The wall bracket 46 includes channels 48 configured to accept projections 44 so that the bracket 20 supporting a flat panel television can be hung on a wall or other suitable surface. The wall bracket 46 includes holes 50 or other structures so that the wall bracket 46 can be mounted to a wall or other suitable surface.

In use, the mounting system shown in FIGS. 10-15 could be used to mount a flat panel display by placing the display on the bracket 20, and the cables 12, 14 would be secured to opposite corners on a rear portion of the flat panel display. The tension on the cables would then be adjusted using the ratchet or other tension adjusting mechanism, and the flat panel display having the mounting system secured thereto would then be hung on the wall bracket 46 that has been mounted to a wall.

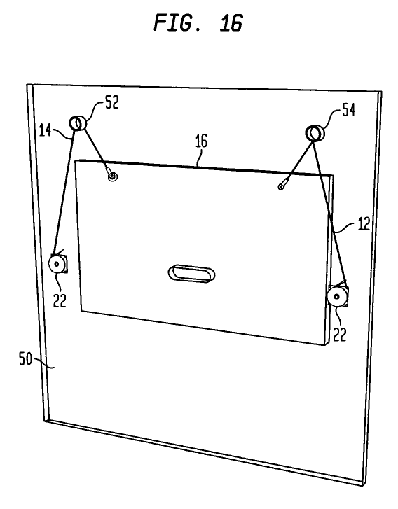

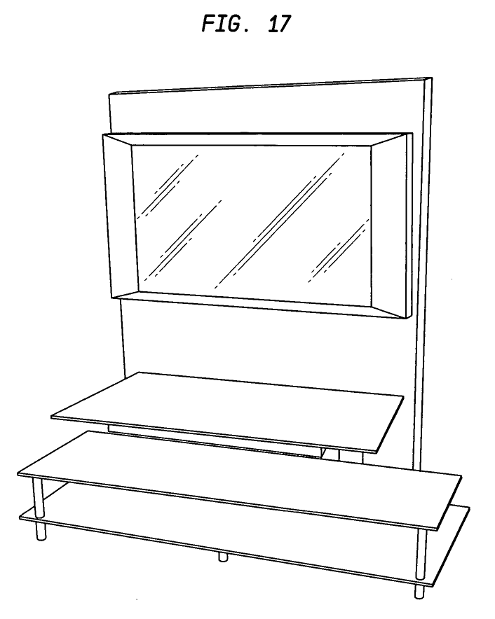

In still another embodiment, the mounting system according to one or more embodiments of the present invention can be used to mount a flat panel display to a panel that forms part of an entertainment system. Referring now to FIG. 16, a panel 50 can include a pair of ratchet devices 22 mounted to a rear portion thereof. Cables 12, 14 are adjustably secured to the ratchet devices 22 and are fed through openings 52, 54 formed in the panel 50. For ease of illustration, the panel is shown as being transparent to show connection of the cables 12, 14 to a flat panel display 16. The cables 12, 14 are then secured to a rear portion of a flat panel display 16, thus suspending the flat panel display from the panel. The position of the flat panel display 16 can be adjusted via a ratchet mechanism that cooperates with the ratchet devices 22.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims and their equivalents.

What is claimed is:

1. A flat panel display mounting system comprising:
a bracket configured to support a lower portion of a flat panel display unit;
a cable including at least a first portion secured with respect to the bracket, and a second portion having a connecting element configured to be connected to the display unit such that the display unit is retained in a secure position.

2. The mounting system of claim 1, further comprising a cable adjustment device mounted on the bracket, the cable being connected to the cable adjustment device.

3. The mounting system of claim 2, further comprising a plurality of cables and a plurality of cable adjustment devices, each of the cable adjustment devices being mounted on bracket and each of the cables having a first portion to a respective one of the cable adjustment devices, each of the cables having a second portion including a connecting element connected to the display unit.

4. The mounting system of claim 3, wherein the cable adjustment device includes a ratchet for adjusting the tension of the cable.

5. The mounting system of claim 4, wherein the connecting element is a clip mounted on one end of the cable having an opening to receive a fastener.

6. A flat panel display mounting system comprising:
a cable adjustment device; and
a pair of cables, each cable having a first end adapted to be secured to a portion of a flat panel display unit, and a second end secured to the cable adjustment device whereby a flat panel display unit is securely positioned to be viewed by a viewer.

7. The mounting system of claim 6, wherein the second end of each cable is secured to a separate cable adjustment device.

8. The mounting system of claim 8, wherein each cable adjustment device comprises a ratchet device.

9. The mounting system of claim 8, wherein each of the pair of cables extend diagonally across a rear surface of the display unit.

10. The mounting system of claim 9, wherein the cables cross each other.

11. The mounting system of claim 10, further comprising a bracket for supporting a lower portion of the display unit.

12. The mounting system of claim 11, wherein the ratchet devices are attached to the bracket.

13. A flat panel display mounting system comprising:
a substantially vertical post secured to a stand;
a bracket configured to support a lower portion of a flat panel display unit, the bracket mounted on the substantially vertical post; and
a cable including at least a first portion secured with respect to the bracket and a second portion having a connecting element configured to be connected to the display unit such that the display unit is retained in a secure position with respect to the stand.

14. A flat panel display mounting system comprising:
a first bracket adapted to be mounted to a substantially vertical surface;
a second bracket configured to support a lower portion of a flat panel display unit;
a post having a first end adapted to be mounted to the first bracket and a second end attached to the second bracket;
a cable including at least a first portion secured with respect to the bracket, and a second portion having a connecting element configured to be connected to the display unit such that the display is retained in a secure position.
